(19) United States
(12) Patent Application Publication
(10) Pub. No.: US 2013/0191500 A1
(43) Pub. Date: Jul. 25, 2013

(54) METHODS AND SYSTEMS FOR PROVIDING A SYNCHRONOUS INTERFACE OVER AN ASYNCHRONOUS MESSAGE BUS

(71) Applicant: eBay Inc., San Jose, CA (US)

(72) Inventors: Mohammed Saleem Shafi, Austin, TX (US); Deepak Seetharam Nadig, San Jose, CA (US); Finn Joakim Kennedy, Austin, TX (US); Eric John Solberg, Austin, TX (US); Leith Shabbot, Austin, TX (US)

(73) Assignee: eBay Inc., San Jose, CA (US)

(21) Appl. No.: 13/670,060

(22) Filed: Nov. 6, 2012

Related U.S. Application Data
(60) Provisional application No. 61/588,527, filed on Jan. 19, 2012.

(51) Int. Cl. H04L 29/08

(52) U.S. Cl. CPC H04L 29/0809
USPC 709/217

(57) ABSTRACT

Techniques for providing a synchronous communication layer between a capability and an asynchronous message bus are presented. A method may receive, over a protocol connection, an initial event message from the first capability. The method may then update the initial event message to include a correlation identifier that is associated with the protocol connection. The updated initial event message is then sent through the asynchronous message bus, which may route the event message to a second capability. Then, the method may receive, through the asynchronous message bus, a response event message from the second capability. The method may then send the response event message to the first capability over the protocol connection. Sending the response event to the first capability may be based at least in part on the response event message including the correlation identifier.

### CROSS REFERENCE TO RELATED APPLICATIONS

This application claims priority from U.S. Provisional Appl. No. 61/588,527, filed Jan. 19, 2012, all of which is incorporated herein by reference in its entirety for all purposes.

### FIELD

Embodiments of the present application relate generally to message processing and more particularly to techniques for processing event messages in a networked environment.

### BACKGROUND

Business is increasingly being conducted in an electronic environment over network connections. This has rapidly increased the speed with which business is conducted but has also presented a number of challenges for the infrastructure that supports these business transactions. For example, typical business transaction architectures may integrate a number of services offered by multiple service providers. However, such integrated services usually involve point-to-point integration between the specific service providers. As a result, typical business transaction architectures are typically designed to include a tightly coupled set of services for performing services on behalf of end users and/or merchants.

Because of the tight coupling between, for example, a business platform and the services offered therein, changes within the infrastructure typically must be propagated throughout the infrastructure or the services must be integrated directly with each other. For example, if a merchant lists items for sale on a listing service and performs payments using a payment service, the merchant generally must develop a specialized middleware layer to integrate the two services with each other. However, if the merchant adds a third service, say an inventory service, the merchant will then need to update the middleware layer so that all three services are integrated to each other. Such an effort can be prone to error and costly in terms of development, time, and money.

### BRIEF DESCRIPTION OF THE DRAWINGS

Embodiments of the present application are illustrated by way of example and not limitation in the figures of the accompanying drawings, in which like references indicate similar elements.

FIG. 1 is a diagram of a network-based commerce system, according to an example embodiment.

FIG. 2 depicts a block diagram of the various modules, in accordance with an example embodiment, that may be included in the synchronization bridge of FIG. 1.

FIG. 3 is a block diagram that shows a format for an event message, according to an example embodiment.

FIG. 4 is a sequence diagram that illustrates a method of transmitting event messages according to an asynchronous communication model, according to an example embodiment.

FIG. 5 is a sequence diagram that illustrates a method of transmitting event messages according to a synchronous communication model, according to an example embodiment.

FIG. 6 is a flowchart illustrating a method of providing a synchronous interface for an asynchronous messaging environment, according to an example embodiment.

FIG. 7 is a flowchart diagram illustrating a method of using multiple computer servers to provide a synchronous interface, according to an example embodiment.

FIG. 8 is a diagram further illustrating a synchronous interface with multiple computer servers, according to an example embodiment.

FIG. 9 is a flowchart diagram illustrating a method of retrieving a response event message from the synchronous bridge of FIG. 1, according to an example embodiment.

FIG. 10 is a diagram of example capabilities that may be utilized by the network-based commerce system of FIG. 1, according to example embodiments.

FIG. 11 is a diagram of machine architecture which implements various aspects according to an example embodiment.

### DETAILED DESCRIPTION

Methods and systems for processing event messages are described. In the following description, for purposes of explanation, numerous specific details are set forth in order to provide a thorough understanding of example embodiments disclosed herein. It will be evident, however, to one of ordinary skill in the art that other example embodiments may be practiced without these specific details.

Some embodiment discussed herein may use an asynchronous message bus to route event messages between various capabilities (e.g., web services). In some embodiments, the asynchronous message bus may route the event messages using a subscription model. In one such subscription model, event messages are published to the synchronous message bus with a given topic. To receive a given event message, other capabilities may subscribe to the given topic.

In some cases, a capability may request that another capability perform a service by sending an event message through the asynchronous message bus that specifies the requested service. Further, once the other capabilities have performed the requested service specified by the event message, the result of the performance of the requested service is returned to the capability via an event message.

Accordingly, the asynchronous message bus may provide a scalable communication model to asynchronously exchange request and response event messages. However, a capability utilizing an asynchronous message bus to exchange request and response event messages may, in some embodiments, have to be configured to maintain state data to relate request event messages to response event messages. For example, the state data (e.g., a lookup data) may be used to lookup data related to an initial event in order to process a response event message.

To provide comparatively convenient message handling, example embodiments may relate to computer-implemented methods, systems, and computer-readable mediums that provide a synchronous communication layer between a capability and an asynchronous message bus. The method may receive, over a protocol connection, an initial event message from the first capability. The method may then update the initial event message to include a correlation identifier that is associated with the protocol connection. The updated initial event message is then sent through the asynchronous message bus, which may route the event message to a second capability. Then, the method may receive, through the asynchronous message bus, a response event message from the second capability. The method may then send the response event message to the first capability over the protocol connection. Sending the response event to the first capability may be based at least in part on the response event message including the correlation identifier.

For clarity of description, a “protocol connection” may be a term used herein that refers to a protocol utilizing a request-response transaction to process requests. In such request-response transactions, a requester may send a request to another entity and then block until the response is received from the other entity. By way of example and not limitation, the hypertext transfer protocol (HTTP) may use a protocol connection to communicate requests and responses. For example, an HTTP client may initiate a request by establishing a Transmission Control Protocol (TCP) connection to a particular port on a server. An HTTP server listening on that port waits for the HTTP client's request message (e.g., a HTTP post message). Upon receiving the request message, the HTTP server may send back a status line, such as “HTTP/1.1 200 OK,” and a message of its own. The body of this message may be a requested resource specified by the HTTP request message, although an error message or other information may also be returned.

As used herein, a request message that is transmitted according a protocol connection may be referred to as a “protocol request message.” As used herein, a response message that is transmitted according to a protocol connection may be referred to as a “protocol response message.”

### Example Systems and Components

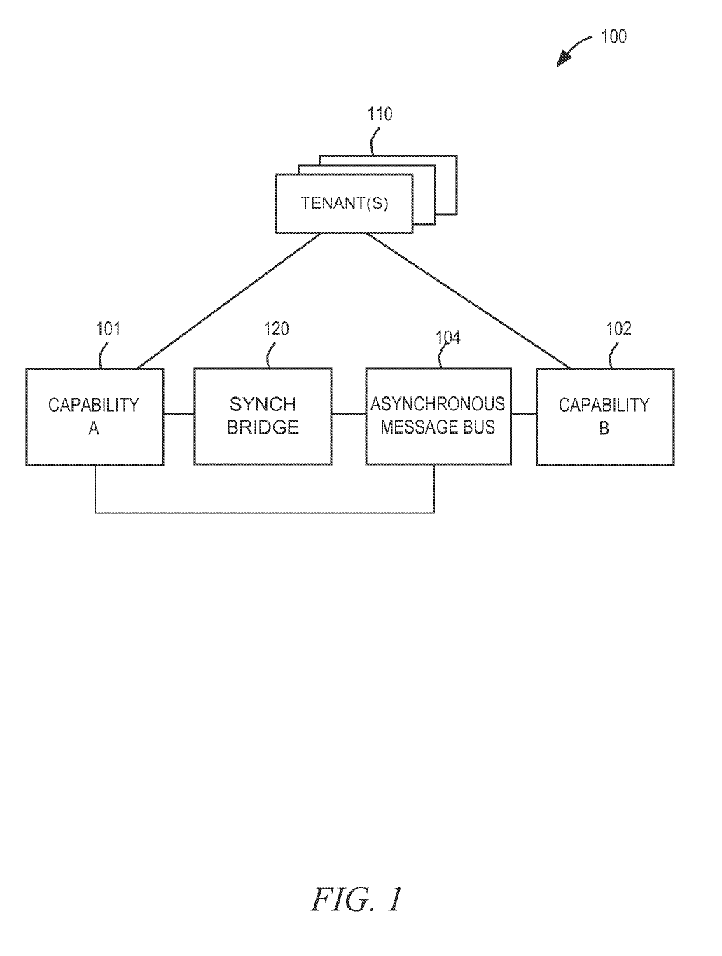

FIG. 1 is a diagram of a network-based commerce system 100, according to an example embodiment. The network-based commerce system 100 is implemented by a machine-accessible and/or readable medium, performed by computer systems, and is accessible over a network. The network may be wired, wireless, or a combination of wired and wireless. In an example embodiment, the network-based commerce system 100 is implemented as a business transaction infrastructure over the Internet or any other suitable network, and is accessible to and interacts with buyers, sellers, service providers, and commerce applications to facilitate business transactions between the buyers and merchants.

The network-based commerce system 100 includes capabilities 101, 102 communicatively coupled to a synchronous bridge 120 and an asynchronous message bus 104. Still further, FIG. 1 shows that the capabilities 101, 102 are associated with a plurality of tenants 110.

The capabilities 101 and 102 may be configured to provide services to tenants 110. According to various embodiments, the capabilities 101, 102 may be a network-addressable computing system that runs applications, web services, and/or application programming interfaces (APIs) that are accessible to the tenants 110. A service that lists an item on a website is an example of a service that may be provided by the capabilities 101, 102. Payment authorization and/or authentication, inventory management, order tracking, store front management, and any other suitable service are additional examples of services that may be provided by the capabilities 101, 102. In some embodiments, the capability 101 may provide a service that is different than the service provided by capability 102. For example, the capability 101 may provide a store front service, whereas the capability 102 may provide a payment service.

The tenants 110 may be computing systems operated by an end-user or associated with an end-user system. Examples of tenants in an e-commerce environment are merchants and merchant systems that sell and/or buy goods.

The asynchronous message bus 104 may be a computer system that provides a messaging infrastructure that allows the capabilities to interact with each other by exchanging event messages. In particular, the asynchronous message bus 104 may route event messages that are decoupled from the capability that is to receive the event message. For example, an event message that does not include an identifier or address that uniquely identifies the capability that is to receive the event message is an example of an event message that is decoupled from the receiving capability.

In some embodiments, the asynchronous message bus 104 may manage routing data used to determine a route for an event message. For example, the messaging manager 106 may access a routing data store (not shown), which may be a database system that manages tables or any other data structure that defines the relationships between topics, capabilities, and tenants. As used herein, a “topic” may refer to a classification of an event message. As will be explained below, event messages may include atopic to indicate the classification of the information contained therein. Further, a capability may use a topic to indicate the classification of event messages that it is interested in receiving.

The synchronous bridge 120 is a computer-addressable computer system that provides a synchronous messaging interface that, from a capabilities perspective, emulates a synchronous request/response message architecture. As is explained in greater detail below, when a capability publishes an event message through the synchronous bridge 120, the synchronous bridge 120 may correlate response event messages with the published event message. In some example embodiments, the synchronous bridge 120 may return the correlated response event messages to the capability when the correlated response event conforms with a message contract. Accordingly, the capability 101 may use the synchronous bridge 120 to communicate in a synchronous request/response manner. Additionally or alternatively, the capability 101 may communicate event messages directly through the asynchronous message bus 104 to communicate in an asynchronous manner.

Although FIG. 1 shows the various components of the network-based commerce system 100 as separate computing systems, it is to be appreciated that one or more of the components of the network-based commerce system 100 may reside within the same computer system. For example, the asynchronous message bus 104 and the messaging manager 106 may be employed within the same computer system.

In some cases, the capability 101 may publish an initial event message through the asynchronous message bus 104 that causes the capability 102 to publish another event message in response to the initial event message. Accordingly, for the purpose of clarity of discussion and not limitation, the capability 101 may be referred to as the initiating capability 101 and the capability 102 may be referred to as the responding capability. Further, the initial event message may refer to an event message that may cause the responding capability to perform a service that has a return result (e.g., an indication of whether the service was performed successfully or not, a search result, an asset, or any other suitable data). In turn, the response event message may be the event message sent by the responding capability 102 that includes the return result of the service performed by the responding capability 102.

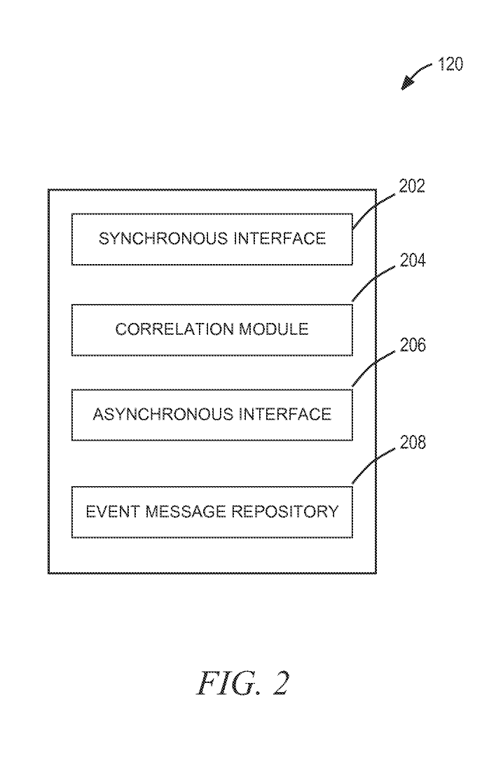

The synchronous bridge 120 is now described in greater detail. FIG. 2 depicts a block diagram of the various modules, in accordance with an example embodiment, that may be included in the synchronous bridge 120. As described above, the synchronous bridge 120 may be a network addressable computer system that provides a processing layer between a capability and the asynchronous message bus 104 that emulates synchronous request/response message communication.

FIG. 2 shows that the synchronous bridge 120 may include a synchronous interface 202, a correlation module 204, an asynchronous interface 206, and an event message repository 208. The synchronous interface 202 may be a computer-implemented module that provides an interface for establishing, maintaining, and closing a protocol connection (e.g., an HTTP connection) with the initiating capability 101 in which the initial event message is received and the response event message is sent.

The correlation module 204 may be a computer-implemented module that correlates one or more response event messages with an initial event message that was previously received.

The asynchronous interface 206 may be a computer-implemented module that communicates (e.g., sends and receives) event messages with the asynchronous message bus 104.

The event message repository 208 is a data store that maintains records of event messages previously received by the synchronous bridge 120. For example, in one embodiment, the event message repository 208 may store response event messages based on the protocol connection between the initiating capability 101 and the synchronous interface 202 closing (e.g., if a timeout condition occurs The event message repository 208 may provide an interface for accessing event messages (e.g., based on a correlation identifier, keywords, and the like).

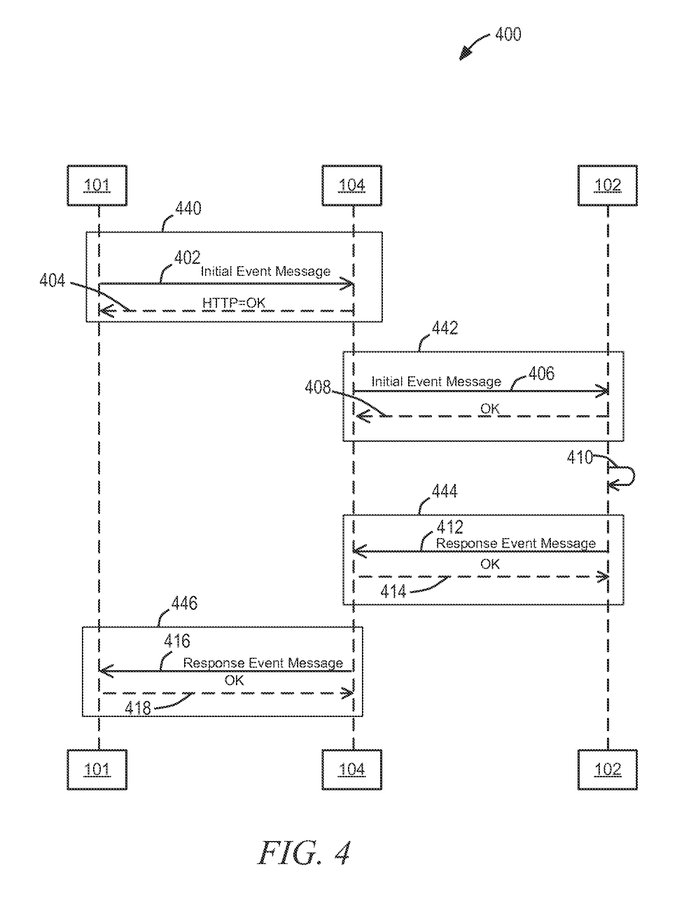

The operation of the synchronous interface 202, the correlation module 204, the asynchronous interface 206, and the event message repository 208 are described in greater detail with reference to FIGS. 4-9.

### Example Event Message

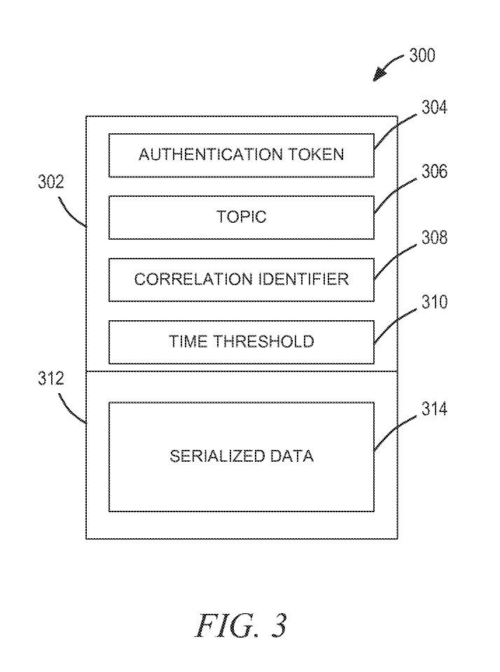

FIG. 3 is a block diagram that shows a format for an event message 300, according to an example embodiment. The event message 300 may be a loosely coupled event message. As used herein, a “loosely coupled event message” may refer to an event message that, when sent, lacks data that explicitly indicates which capabilities are to receive the event message 300. In contrast, a tightly coupled event message may include a field that stores a destination identifier, address, or any other data that uniquely identifies the capability that is to receive the event message.

FIG. 3 shows that the event message 300 includes a header 302 and a payload 312. The header 302 includes fields that store data used by the asynchronous message bus 104 to properly route a received event message o the appropriate capabilities. In particular, as shown in FIG. 3, the header 302 of the event message 300 may include an authentication token field 304, a topic field 306, a correlation identifier 308, and a time threshold field 310. As will be explained below, the authentication token field 304 may store an authentication token that validates a given capability to perform operations or services on behalf of the tenant In other words, the authentication token field 304 may indicate that the given capability is authorized to receive and/or transmit event messages on behalf of a given tenant. In some embodiments, the authentication token field 304 may store a digitally signed token issued by the asynchronous message bus 104.

The topic field 306 is a field that characterizes the type of event message being sent or received. The topic field 306 may store a topic, such as a word, phrase, number, letter, symbol, or any combination thereof that has a particular meaning within the network-based commerce system 100, such as, for example, between capabilities and/or tenants. For example, the capabilities 101 and 102 may use the topic “ITEM-SALE” to tag event messages that include data relating to the sale of an item. Accordingly, the capability 101 may include the “ITEM-SALE” topic in an event message when the capability 101 wants to send with information related to the sale of an item to the network-based commerce system 100. Further, capability 102 may be interested in receiving event messages related to items sold in the network-based commerce system 100. Accordingly, the capability 102 may subscribe (e.g., under the direction of the tenant 110) with the asynchronous message bus 104 to receive event messages with the topic field 306 set to “ITEM-SALE.”

The correlation identifier field 308 may be a data field within the event message 300 that stores a unique identifier associated with an initial event message. In some embodiments, the correlation identifier field 308 is populated with a correlation identifier generated by the synchronous bridge 120. Thus, when the initiating capability 101 communicates the event message, the correlation identifier field 308 may include invalid, null, or absent data. When the synchronous bridge 120 receives the event message, the synchronous bridge 120 may insert a generated correlation identifier in the correlation identifier field 308, and the event message with the inserted generated correlation identifier is then communicated to the receiving capabilities.

The time threshold field 310 may be a data field within the event message 300 that stores an indication of time, which is usable to specify when the synchronous bridge 120 is to terminate a protocol connection. For example, the initiating capability may store data in the time threshold field 310 that represents three seconds. The synchronous bridge 120, upon receiving an initial event message with such a time threshold field 310, may signal the initiating capability that the response event message was not received if the three seconds have elapsed.

The payload 312 stores data that is specific to the event that generated the event message. Accordingly, the payload 312 stores the data that is to be used by the receiving capability to react to or otherwise process the event message. It is to be appreciated that the content and format of the payload 312 is determined by an event message contract (e.g., definition) agreed upon by the capabilities. The operations performed by the synchronous bridge 120 and the asynchronous message bus 104, in some example embodiments, may be agnostic to this definition.

### Methods of Exchanging Event Messages

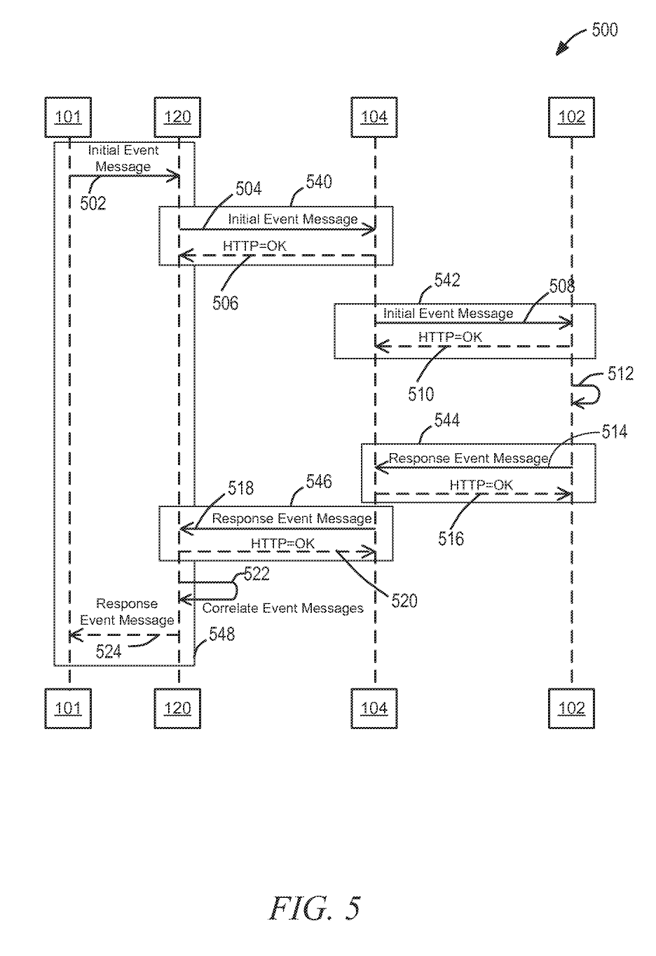

As described above with reference to FIG. 2, the synchronous bridge 120 may include a synchronous interface 202 operable to provide synchronous communication to the initiating capability 101. To better illustrate the differences between synchronous and asynchronous messaging, an example embodiment where the initiating capability 101 utilizes an asynchronous message passing model is now described with reference to FIG. 4 and then contrasted with an example embodiment where the initiating capability 101 utilizes a synchronous message passing model, which is described with reference to FIG. 5.

FIG. 4 is a sequence diagram that illustrates a method 400 of transmitting event messages according to an asynchronous communication model, according to example embodiments. In an embodiment, the method 400 is performed by components shown in FIGS. 1, 2, and 3. It is to be appreciated that the method 400 may be processed across multiple processors and may be multithreaded, meaning that duplicate operations of the method 400 may be performed within the same computation environment and may cooperate with one another to perform the processing of the method 400 depicted in FIG. 4.

The method 400 may begin at operation 402 when the initiating capability 101 sends an initial event message to the asynchronous message bus 104. Consistent with example embodiments, the initiating capability 101 may send the event message in a protocol request message, such as an HTTP POST method. By way of example and not limitation, the initial event message may include the topic “account/search” and the payload of the event message may include a search criteria. Although the components of FIG. 4 are described as sending event messages using HTTP messages, it is to be appreciated that in other embodiments contemplated by this disclosure, the event message may be sent by the initiating capability 101 using any other suitable communication protocol, such as TCP, user datagram protocol (UDP), file transfer protocol (FTP), general inter-ORB (object request brokers) protocol, Java remote method invocation (RMI), distributed component object model (DCOM), dynamic data exchange (DDE), or simple object access protocol (SOAP).

The operation 402 may create a protocol connection 440 (e.g., HTTP connection) between the initiating capability 101 and the asynchronous message bus 104.

At operation 404, after receiving the protocol request message, the asynchronous message bus 104 may send a protocol response message back to the initiating capability 101 over the protocol connection 440. A “protocol response message,” as used herein, may refer to a status line that indicates the status of the communication protocol. In some embodiments, the status line may indicate whether the protocol request message was properly formatted and properly received by the asynchronous message bus 104. An example of a protocol response message may be a HTTP response message with a ‘200’ status code. In some embodiments, the initiating capability 101 and/or the asynchronous message bus 104 may close the protocol connection 440 after the protocol response message is communicated to the initiating capability 101.

At operation 406, the asynchronous message bus 104 may route the initial event message to the responding capability 102 by sending the initial event message to the responding capability 102 over a connection protocol 442. The initial event message may be sent using another protocol request message. In some embodiments, the asynchronous message bus 104 may route the event message to the responding capability 102 based, at least in part, on routing data maintained by the asynchronous message bus 104 that maps the initiating capability 101 to the topic of the event message. For example, the responding capability 102 may have previously subscribed, on behalf of one of the tenants 110, to the “account/search” topic, which, according to the example described above, was specified by the initial event message.

At operation 408, upon receiving the event message sent by operation 406, the responding capability 102 may send a protocol response message to the asynchronous message bus 104. For example the protocol response message may be an HTTP response message with a response code set to ‘200’. The protocol connection 442 may be closed by the responding capability 102 and/or the asynchronous message bus 104 after the protocol response message is sent in operation 408.

Once the event message is received, the responding capability 102 may then process the event message at operation 410. Processing the event message may involve the responding capability 102 performing one or more services associated with the event message (e.g., based on the topic and the payload). By way of example and not limitation, the responding capability may perform a search on a database use a search criteria specified by the payload of the event message.

At operation 412, the responding capability 102 may send a request protocol message with a response event message to the asynchronous message bus 104. The response event message may include data that characterizes the result of performing a service specified by the initial event message. For example, in the case that the initial event message requests a search to be performed, the response event message may include search results. At operation 414, in response to receiving the protocol request message, the asynchronous message bus 104 may send a protocol response message back to the responding capability 102. As FIG. 4 shows, the request event message and the response event message may be sent via the protocol connection 444.

At operation 416, the asynchronous message bus 104 may route the response event message to the initiating capability 101 in a protocol request message. In turn, at operation 418, the initiating capability 101 may send a protocol response message back to the asynchronous message bus 104 to indicate that request protocol message was received. As FIG. 4 shows, the request protocol message and the response protocol message are sent over the protocol connection 446.

Accordingly, the initiating capability 101 may send an initial event message through one protocol connection (e.g., the protocol connection 440) and then, at some later time, asynchronously receive a corresponding response event message through a different protocol connection (e.g., protocol connection 446).

It is to be appreciated that, according to some embodiments, the initial capability 101 may include a multiple computer systems each configured to send and receive event messages. Accordingly, in some cases, the initial capability may use a computer system to send the initial event message but may then receive the corresponding response event message through a different computer system. Because of this, some embodiments providing the asynchronous communication shown in FIG. 4 may manage state data relating to the initial event message in order to process the response event message.

In contrast to FIG. 4, FIG. 5 is a sequence diagram that illustrates a method 500 of transmitting event messages according to a synchronous communication model, according to example embodiments. In an embodiment, the method 500 is performed by components shown in FIGS. 1, 2, and 3.

The method 500 may begin at operation 502 when the initiating capability 101 sends an initial event message to the synchronous bridge 120. Similar to operation 402 of FIG. 4, the initiating capability 101 may send the initial event message in the message body of an HTTP POST method. It is to be appreciated that the event message may be sent by the initiating capability 101 using any other suitable distributed communication protocol, such as TCP, FTP, general inter-ORB protocol, Java RMI, DCOM, DDE, or SOAP.

At operation 504, the synchronous bridge 120 may use the protocol connection 540 to communicate the initial event message to the asynchronous message bus 104 in a protocol request message. At operation 506, using the protocol connection 540, the asynchronous message bus 104 may send a protocol response message back to the synchronous bridge 120 indicating that the protocol request message is received.

Operations 508, 510, 512, 514, and 516, in some embodiments, match operations 406, 408, 410, 412, and 418 of FIG. 4, respectively. For example, operation 508 may involve the asynchronous message bus 104 communicating the initial event message to the responding capability 102 over the protocol connection 542. Operation 510 may involve the responding capability 102 sending a protocol response message indicating that the initial event message was received successfully over the protocol connection 542. Operation 512 may involve the responding capability 102 performing a service based on data from the initial event message. Operation 514 may involve the responding capability 102 communicating a response event message to the asynchronous message bus 104 over the protocol connection 544. Operation 516 may involve the asynchronous message bus 104 sending, over the protocol connection 544, a protocol response message back to the responding capability 102 to indicate that the response event message was received successfully.

At operation 518, the asynchronous message bus 104 may send a protocol request message (e.g., an HTTP Post message) with the response message in the body of the protocol request message to the synchronous bridge 120. The protocol request message may be sent over the protocol connection 546. In response, at operation 520, the synchronous bridge 120 may send a protocol response message back to the asynchronous message bus 104 to indicate that the protocol request message sent in operation 518 was received successfully.

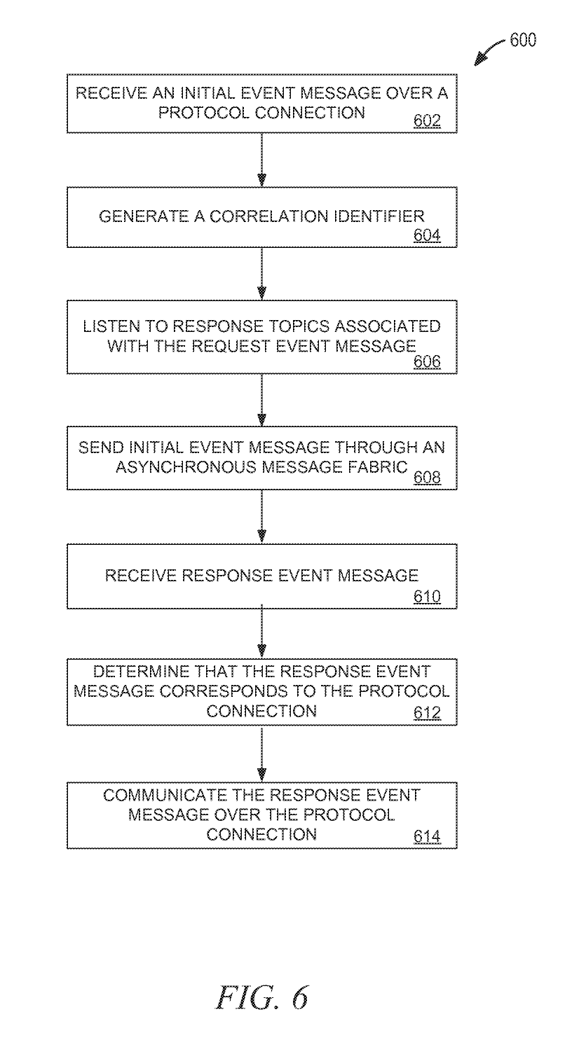

At operation 522, the synchronous bridge 120 may correlate the response event message with the initial event message previously sent at operation 504. In example embodiments, correlating the response event message with the initial event message may involve operations involving determining that the response event message is the response to the initial event message. The operations involved with correlating event messages are described in greater detail with respect to FIGS. 6-9.

Once the response event message is correlated with the initial event message, the synchronous bridge 120 sends the response event message in operation 524 to the initiating capability 101 using a protocol response message sent over the protocol connect 548.

It is to be appreciated that in the synchronous communication model shown in FIG. 5, the initiating capability 101 sends the initial event message and receives the response event message through the same protocol connection (e.g., protocol connection 548). In contrast, in the asynchronous communication model shown in FIG. 4, the initiating capability 101 sends the initial event message and receives the response event message through different protocol connections (e.g., 440 and 446). Because the initiating capability 101 receives the response event message through the same protocol connection, it is possible in some cases that the initiating capability 101 does not have to maintain state data to relate the response event message to the initial event message.

FIG. 6 is a flowchart illustrating a method 600 of providing a synchronous interface for an asynchronous messaging environment, according to example embodiments. In some embodiments, the method 600 may be performed using any of the systems, components, modules shown in FIGS. 1-5 and, accordingly, is described by way of example with reference thereto.

The method 600 may begin at operation 602 when the synchronous interface 202 of FIG. 2 receives an initial event message from the initiating capability 101 of FIG. 1. In some embodiments, the initial event message is transmitted over a protocol connection, such as an HTTP connection. The initial event message may include a topic (e.g., “account/search”) that characterizes a service being requested by the initial event message. As described above, FIG. 3 illustrates an example format of an event message that includes a topic (e.g., see the topic field 306).

It is to be appreciated that according to some embodiments, the initial event message lacks data that specifies the recipients (e.g., the responding capability 102) of the initial event message. Such may be the case because the initial capability 101 and the responding capability 102 may communicate with each other indirectly through the asynchronous message bus 104, which utilizes an event driven messaging system that routes event Messages to recipients based on the recipients subscribing to a given topics.

At operation 604, the correlation module 204 may generate a correlation identifier associated with the initial event message. Operation 604 may further include mapping the correlation identifier to the protocol connection used to receive the initial event message. As described above, an HTTP connection is an example of a protocol connection.

At operation 606, the correlation module 204 listens for response event messages associated with the initial event message. In one embodiment, the correlation module 204 may listen for response event messages by subscribing to a response topic, or response topics, associated with the topic in the initial event message. In some embodiments, the response topics may be fields specified by the initial event message. In other embodiments, the correlation module 204 may listen to response topics based, at least in part, on topic associations maintained by the correlation module 204. For example, the correlation module 204 may store a topic association that maps the topic “account/search” with the topics “account/searchFailed” and “account/searchSucceeded.” The topic associations may be determined by event message contracts that define the relationships between different types of event messages. Such contracts may specify that an initial event message with one topic (e.g., “account/search”) may result in response event messages with other topics (e.g., “account/searchFailed” or “account/searchSucceeded”).

In embodiments that subscribe to response event topics, once the response topics are determined (e.g., as may be specified by fields of the initial event message or topic associations maintained by the correlation module 204), the correlation module 204 then sends a subscription message to the asynchronous message bus 104 to subscribe the synchronous bridge 120 with the response event topics.

Alternatively or additionally, embodiments may listen for response event messages using mechanisms other than subscribing to response topics. For example, in some embodiments, the correlation module 204 may add a correlation identifier in the correlation identifier field of the initial event message, shown in FIG. 3. A valid correlation identifier in an event message may be operable as a signal to other components of the network-based commerce system 100 that response event messages corresponding to the initial event message are to be sent through the synchronous bridge 120. In such cases, when the responding capability 102 handles an initial event message with a correlation identifier, the responding capability 102 may subsequently transmit a response event message that includes the same correlation identifier. Further, the asynchronous message bus 104, upon detecting a response event message with a correlation identifier, may route the response event message to the synchronous bridge 120.

At operation 608, the asynchronous interface 206 sends the initial event message to the asynchronous message bus 104. The initial event message may include header data for facilitating asynchronous communication. For example, as described above with reference to FIG. 3, the initial event message may include fields specifying a topic, an authorization token, a tenant identifier, and, in some embodiments, a correlation identifier. In some embodiments, the asynchronous message bus 104 may then use the header data to determine that the initial event message is to be received by responding capability 102. For example, the responding capability 102 may have previously subscribed to the topic identified by the initial event message on behalf of the tenant identified by the initial event message.

At operation 610, the asynchronous interface 206 of the synchronous bridge 120 may receive a response event message. In some embodiments, the asynchronous interface 206 receives the response event message when the responding capability 102 transmits the response event message through the asynchronous message bus 104. In other embodiments, the responding capability 102 may send the response event message directly to the synchronous bridge 120. In some embodiments, the response event message may include the correlation identifier generated for the initial event message. Consistent with example embodiments, either the asynchronous message bus 104 or the responding capability 102 may send the response event message to the synchronous bridge 120 based on detecting that the initial event message includes a correlation identifier.

At operation 612, the correlation module 204 may determine that the response event message corresponds to the protocol connection through which the initial event message was communicated. For example, operation 612 may involve the correlation module 204 determining that the correlation identifier included in the response event message matches the correlation identifier previously generated in response to the receiving the initial event message.

At operation 614, the synchronous interface 202 may send the response event message over the protocol connection used to receive the initial event message. Sending the response event message may involve the synchronous interface 202 sending an HTTP response message with the response event message in the body of the HTTP response message.

It is to be appreciated that in some cases the method 600 may provide capabilities, such as the initiating capability 101, with a method of communicating event messages in a request/response communication model even when the underlying messaging systems (e.g., the asynchronous message bus 104) communicates with an event driven communication model.

In some embodiments, the modules of the synchronous bridge 120 may operate on a cluster, array, or any other suitable arrangement of computer servers to distribute various functions. For example, the synchronous interface 202 may be replicated in an array of computer servers to load balance the receipt and transmission of event messages from many different initiating capabilities. When the synchronous interface 202, for example, is replicated across multiple computer servers, the correlation module 204 may operate in such a way that the same computer server within the synchronous bridge 120 is used to both (a) receive le initial event message and (b) transmit the response event message.

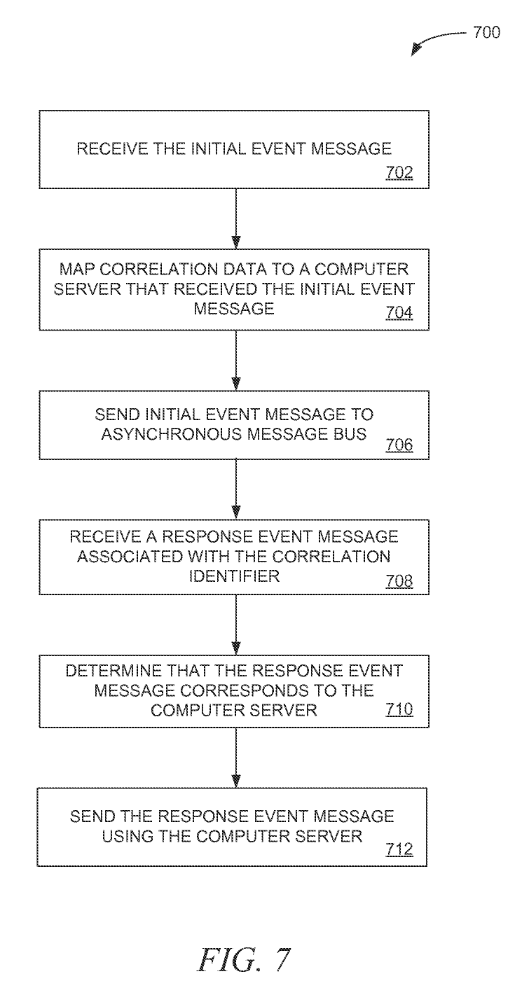

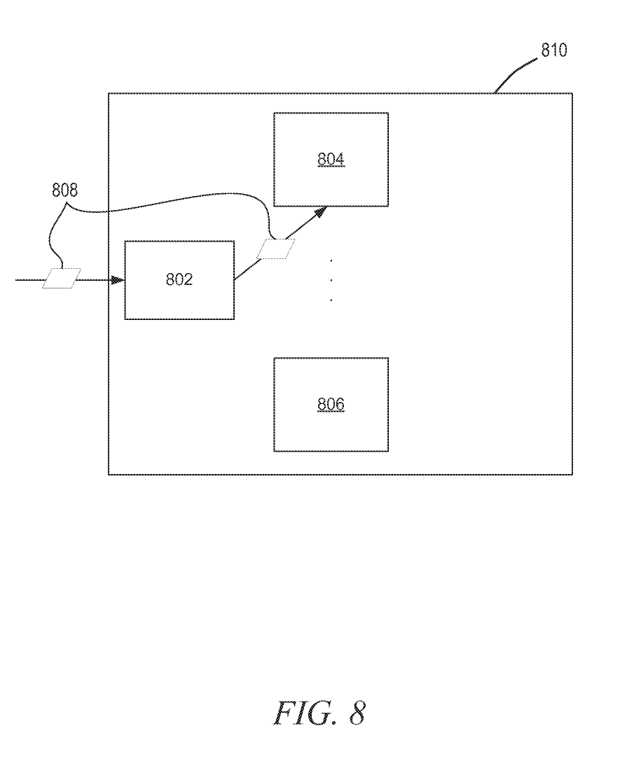

FIG. 7 is a flowchart diagram illustrating a method 700 of using multiple computer servers to provide a synchronous interface, according to an example embodiment. The method 700 may begin at operation 702 when a computer server of the synchronous interface 202 receives an initial event message from the initiating capability 101. In some embodiments, the synchronous interface may include load balancing functionality that directs the initial event message to the computer server that receives the initial event message. For example, FIG. 8 is a diagram further illustrating asynchronous interface 810 with multiple computer servers, according to an example embodiment. FIG. 8 shows that the synchronous interface 810 may include a load balancer 802 and computer servers 804 and 806, and possibly additional computer servers. The load balancer 802 may direct a protocol request message 808 to a given computer server (e.g., the computer server 804). The load balancer 802 may use any number of factors to route the protocol message 808 to the computer server 804, such as response times, geographic location, processing load, capacity, or any other suitable metric. The computer servers 804, 806 may be physical or virtual servers configured to perform operations associated with the synchronous interface 810, such as those operations described with reference to FIGS. 4-7 and 8.

With reference back to FIG. 7, at operation 704, the correlation module 204 may map correlation data (e.g., a correlation identifier) to the computer server that received the initial event message. In some embodiments, mapping the correlation data may involve updating a table or any other suitable data structure that associates the correlation identifier with the computer server that received the initial event message (e.g., the computer server 804 of FIG. 8). In an example embodiment, the correlation identifier may be associated with a network address of the computer server that received the initial event message.

At operation 706, the asynchronous interface 206 transmits (e.g., using an HTTP Post message) the initial event message to the asynchronous message bus 104, which, in turn, routes the initial event massage to the responding capability 102. In some embodiments, the initial event message includes a header field that includes the correlation identifier.

At operation 708, the asynchronous interface 206 receives the response event message from the responding capability 102, possibly through the asynchronous message bus 104. The response event message may include a header field containing the correlation identifier generated when the initial event message was received (e.g., operation 704).

At operation 710, the asynchronous interface 206 may determine that the response event message corresponds to the computer server that received the initial event message. For example, the asynchronous interface 206 may match the correlation identifier included in the response event message with the correlation data (e.g., the correlation identifier) associated with the computer server. In other embodiments, the asynchronous interface 206 may utilize aloud balancer with sticky sessions (e.g., for HTTP) to determine that the response event message corresponds to the computer server that received the initial event message.

At operation 712, the synchronous interface 202 may send the response event message to the initiating capability 102 using the computer server that received the initial event message. The sending of the response event message performed at operation 712 may involve the synchronous interface 202 routing the response event message to the computer server that is holding the protocol connection to the initiating capability 101. In turn, the computer server then sends the response event message to the initiating capability 101 using the protocol connection used to receive the initial event message. In some embodiments, the synchronous interface 202 may send the response event message to the initiating capability 101 using a load balancer with sticky sessions (e.g., for HTTP).

Thus, according to some embodiments, the operations of the method 700 may be used to provide a synchronous messaging model where the synchronous interface includes multiple computer servers.

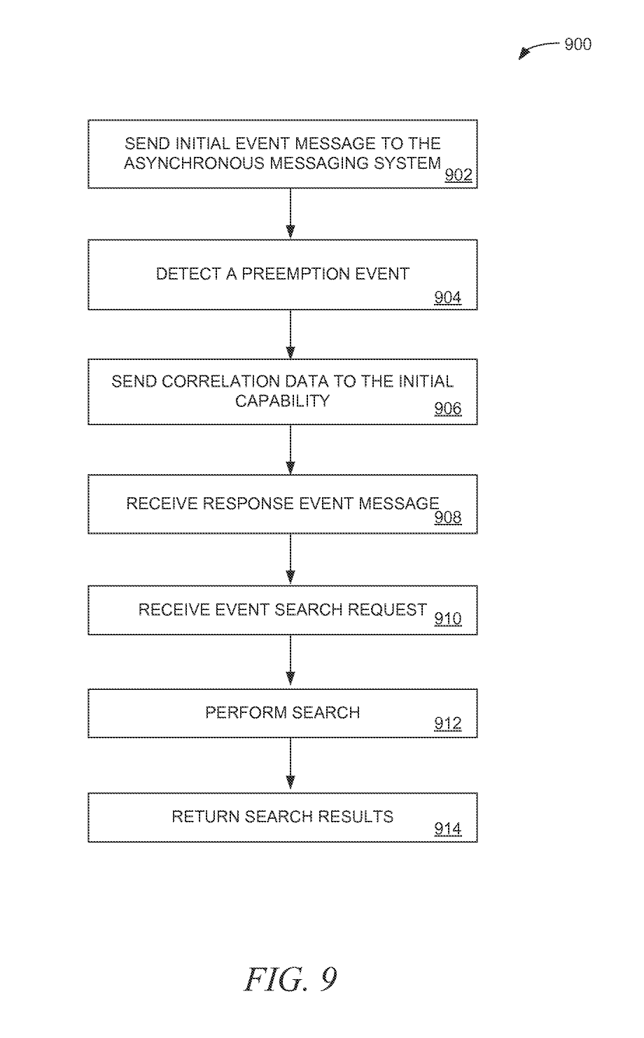

In some embodiments, the protocol connection between the initiating capability 101 and the asynchronous interface 202 may be terminated before the synchronous bridge 120 receives the response event message from the responding capability 102. For example, a time-out condition may occur. In such situations, the synchronous bridge 120 may provide a mechanism for initiating capabilities to “pull” response event messages from the synchronous bridge 120. FIG. 9 is a flowchart diagram illustrating a method 900 of retrieving a response event message from the synchronous bridge 120, according to an example embodiment. The method 900 may begin at operation 902 when the synchronous interface 202 sends an initial event message to the asynchronous message bus 104. As described above, the synchronous interface 202 may receive the initial event message from the initiating capability 101.

At operation 904, the synchronous interface 202 may detect a termination event. A “termination event,” as used herein, may be a term that refers to an event detected by the synchronous interface 202 that signals that the protocol connection between the initiating capability 101 and the synchronous interface 202 is to be closed. For example, in some embodiments, the synchronous interface 202 may detect that a determinable amount of time has elapsed since the initial event message was received by the synchronous interface 202 or since the synchronous interface 202 has sent the initial event message to the asynchronous message bus 104. The determinable amount of time may be a threshold time specified in the protocol request message sent to the synchronous interface 202 or may be a threshold time specified by the synchronous bridge 120.

After the synchronous interface 202 detects the termination event, the synchronous interface 202 may send, among other things, a correlation identifier to the initiating capability 101. This is shown as operation 906. In some embodiments, the correlation identifier may be sent in a protocol response message indicating that the protocol request message has timed out. In some embodiments, operation 906 terminates the protocol connection previously used to transmit the initial event message.

At operation 908, the asynchronous interface 206 may receive the response event message. It is to be appreciated that at the time operation 908 is performed, the protocol connection used to receive the initial event message is closed. Accordingly, upon detecting that the protocol connection is closed, the asynchronous interface 206 may store the response event message in a manner that may be indexed by the correlation identifier. For example, the asynchronous interface 206 may store the response event message in the event message repository 208 of FIG. 2.

At operation 910, the synchronous interface 202 may receive from the initiating capability 101 a search request from initiating capability 101. The search request may include the correlation identifier previously provided to the initial capability (see, e.g., operation 906). Further, in some embodiments, the search request may include search criteria that include logical operators (e.g., logical and, or, not, xor, equality, and the like) and keywords to limit the search results to those response event messages that match the search criteria.

At operation 912, the synchronous interface 202 may then use the search criteria to perform a search on the response event messages previously received. In some embodiments, the search performed at operation 912 may involve accessing the event message repository 208 and identifying those response event messages indexed or otherwise associated with the correlation identifier submitted at operation 910.

At operation 914, the synchronous interface 202 returns the search results of the search, performed at operation 912, to the initiating capability 101. In particular, operation 914 may return the response event message received at operation 908.

### Example Capabilities

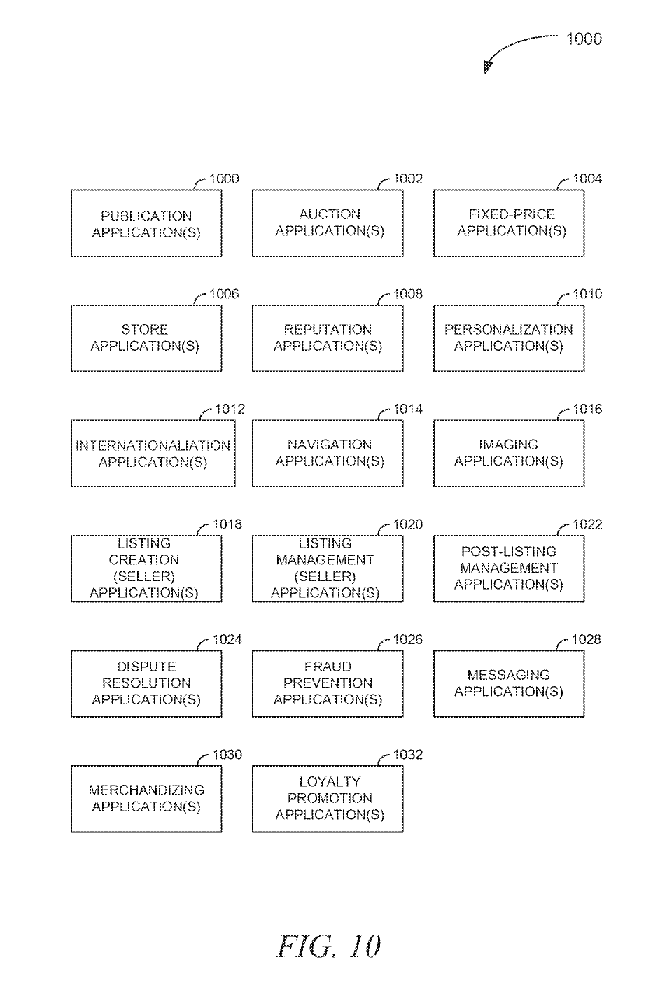

FIG. 10 is a diagram of example capabilities 1000 that may be utilized by the network-based commerce system 100 of FIG. 1, according to example embodiments. The capabilities 1040 may be hosted on dedicated or shared server machines (not shown) that are communicatively coupled to the synchronous bridge 120 and/or the asynchronous message bus 104 to enable communications between the server machines. The architecture of one such example server machine is provided below.

The capabilities 1040 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the capabilities 1040 are shown to include at least one publication application 1000 and one or more auction applications 1002 which support auction-format listing and price setting mechanisms (e.g., English, Dutch, Vickrey, Chinese, Double, Reverse auctions etc.). The various auction applications 1002 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 1004 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 1006 allow a seller to group listings within a “virtual” store, which may be branded and otherwise personalized by and for the seller. Such a virtual store may also offer promotions, incentives and features that are specific and personalized to a relevant seller.

Reputation applications 1008 allow users that transact, utilizing the network-based commerce system 100, to establish, build and maintain reputations, which may be made available and published to potential trading partners. Consider that where, for example, the network-based commerce system 100 supports person-to-person trading, users may otherwise have no history or other reference information whereby the trustworthiness and credibility of potential trading partners may be assessed. The reputation applications 1008 allow a user, for example through feedback provided by other transaction partners, to establish a reputation within the network-based commerce system 100 over time. Other potential trading partners may then reference such a reputation for the purposes of assessing credibility and trustworthiness.

Personalization applications 1010 allow users of the network-based commerce system 100 to personalize various aspects of their interactions with the network-based commerce system 100. For example a user may, utilizing an appropriate personalization application 1010, create a personalized reference page at which information regarding transactions to which the user is (or has been) a party may be viewed. Further, a personalization application 1010 may enable a user to personalize listings and other aspects of their interactions with the network-based commerce system 100 and other parties.

The network-based commerce system 100 may support a number of marketplace capabilities that are customized, for example, for specific geographic regions. A version of the network-based commerce system 100 may be customized for the United Kingdom, whereas another version of the network-based commerce system 100 may be customized for the United States. Each of these versions may operate as an independent marketplace, or may be customized (or internationalized) presentations of a common underlying marketplace. The network-based commerce system 100 may accordingly include a number of internationalization applications 1012 that customize information (and/or the presentation of information) by the network-based commerce system 100 according to predetermined criteria (e.g., geographic, demographic or marketplace criteria). For example, the internationalization applications 1012 may be used to support the customization of information for a number of regional websites that are operated by the network-based commerce system 100 and that are accessible via respective web servers.

Navigation of the network-based commerce system 100 may be facilitated by one or more navigation applications 1014. For example, a search application (as an example of a navigation application) may enable key word searches of listings published via the network-based commerce system 1100. A browse application may allow users to browse various category, catalogue, or inventory data structures according to which listings may be classified within the network-based commerce system 100. Various other navigation applications may be provided to supplement the search and browsing applications.

In order to make listings, available via the network-based commerce system 100, as visually informing and attractive as possible, the capabilities 1040 may include one or more imaging applications 1016 utilizing which users may upload images for inclusion within listings. An imaging application 1016 also operates to incorporate images within viewed listings. The imaging applications 1016 may also support one or more promotional features, such as image galleries that are presented to potential buyers. For example, sellers may pay an additional fee to have an image included within a gallery of images for promoted items.

Listing creation applications 1018 allow sellers conveniently to author listings pertaining to goods or services that they wish to transact via the network-based commerce system 100, and listing management applications 1020 allow sellers to manage such listings. Specifically, where a particular seller has authored and/or published a large number of listings, the management of such listings may present a challenge. The listing management applications 1020 provide a number of features (e.g., auto-relisting, inventory level monitors, etc.) to assist the seller in managing such listings. One or more post-listing management applications 1022 also assist sellers with a number of activities that typically occur post-listing. For example, upon completion of an auction facilitated by one or more auction applications 1002, a seller may wish to leave feedback regarding a particular buyer. To this end, a post-listing management application 1022 may provide an interface to one or more reputation applications 1008, so as to allow the seller conveniently to provide feedback regarding multiple buyers to the reputation applications 1008.

Dispute resolution applications 1024 provide mechanisms whereby disputes arising between transacting parties may be resolved. For example, the dispute resolution applications 1024 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 1026 implement fraud detection and prevention mechanisms to reduce the occurrence of fraud within the network-based commerce system 100.

Messaging applications 1028 are responsible for the generation and delivery of messages to users of the network-based commerce system 100, such messages for example advising users regarding the status of listings at the network-based commerce system 100 (e.g., providing “outbid” notices to bidders during an auction process or to provide promotional and merchandising information to users). Respective messaging applications 1028 may utilize any one of a number of message delivery networks and platforms to deliver messages to users. For example, messaging applications 1028 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 1030 support various merchandising functions that are made available to sellers to enable sellers to increase sales via the network-based commerce system 100. The merchandising applications 1030 also operate the various merchandising features that may be invoked by setters, and may monitor and track the success of merchandising strategies employed by sellers.

The network-based commerce system 100 itself, or one or more parties that transact via the network-based commerce system 100, may operate loyalty programs that are supported by one or more loyalty/promotions applications 1032. For example, a buyer may earn loyally or promotions points for each transaction established and/or concluded with a particular seller, and be offered a reward for which accumulated loyalty points can be redeemed.

### Example Computer Systems

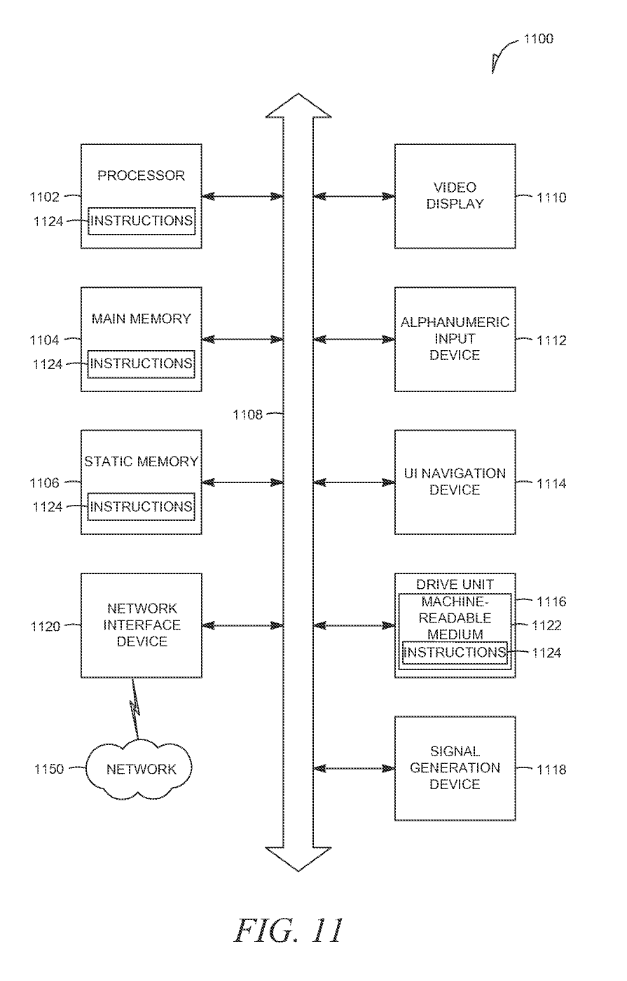

FIG. 11 is a diagram of machine architecture 1100 which implements various aspects of the invention, according to an example embodiment. The machine includes a set of instructions, which when executed on the machine cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer architecture 1100 includes a processor 1102 (e.g., a central processing unit (CPU) a graphics processing unit (CPU) or both), a main memory 1104 and a static memory 1106, which communicate with each other via a bus 1108. The architecture 1100 may further include a video display unit 1110 (e.g., a liquid crystal display (LCD) or a cathode ray tube (CRT)). The architecture 1100 also includes an alphanumeric input device 1112 (e.g., a keyboard), a cursor control device 1114 (e.g., a mouse), a disk drive unit 1116, a signal generation device 1118 (e.g., a speaker) and a network interface device 1120.

The disk drive unit 1116 includes a machine-readable medium 1122 on which is stored one or more sets of instructions (e.g., software 1124) embodying any one or more of the methodologies or functions described herein. The software 1124 may also reside, completely or at least partially, within the main memory 1104 and/or within the processor 1102 during execution thereof by the architecture 1100, the main memory 1104 and the processor 1102 also constituting machine-readable media.

The software 1124 may further be transmitted or received over a network 826 via the network interface device 1120.

While the machine-readable medium 1122 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to provide novel business event processing have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The above description is illustrative, and not restrictive. Many other embodiments will be apparent to those of ordinary skill in the art upon reviewing the above description. The scope of embodiments should therefore be determined with reference to the appended claims, along with the full scope of equivalents to which such claims are entitled.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented system communicatively coupled to a first capability and an asynchronous message bus, the computer-implemented system comprising:
at least one processor;
a synchronous interface implemented by the at least one processor and configured to receive an initial event message from the first capability, the initial event message being received over a protocol connection;
a correlation module implemented by the at least one processor and configured to update the initial event message to include a correlation identifier that is associated with the protocol connection;
an asynchronous interface implemented by the at least one processor and configured to:
send the updated initial event message through the asynchronous message bus, and
receive, through the asynchronous message bus, a response event message from a second capability; and
the synchronous interface being further configured to send the response event message to the first capability over the protocol connection based at least in part on the response event message including the correlation identifier.

2. The computer-implemented system of claim 1, wherein the protocol connection is a hypertext transfer protocol (HTTP) connection.

3. The computer-implemented system of claim 1, wherein the synchronous interface includes a plurality of server computers, and the correlation module is further configured to map the correlation identifier to one of the plurality of server computers that received the initial event message.

4. The computer-implemented system of claim 3, wherein the correlation module is further configured to determine that the response event message corresponds to the one of the plurality of computer servers, and the synchronous interface is further configured to send the response event message to the first capability using the one of the plurality of server computers.

5. The computer-implemented system of claim 1, wherein the synchronous interface is further configured to receive the initial event message in a hypertext transfer protocol (HTTP) post message.

6. The computer-implemented system of claim 5, wherein the synchronous interface is further configured to send the response event message in a HTTP response message.

7. The computer-implemented system of claim 1, wherein the asynchronous interface sends the initial event message to the asynchronous message bus in a hypertext transfer protocol (HTTP) request message.

8. The computer-implemented system of claim 7, wherein the HTTP request message is sent using another protocol connection.

9. The computer-implemented system of claim 7, wherein the synchronous interface is further configured to maintain the protocol connection until the response event message is sent to the first capability.

10. The computer-implemented system of claim 1, wherein the synchronous interface is further configured to close the protocol connection based at least in part on detecting a termination event, and the synchronous interface is further configured to send a protocol response message with the correlation identifier to the first capability based on the detection of the termination event.

11. A computer-implemented method of providing a synchronous communication layer between a capability and an asynchronous message bus, the method comprising:
receiving an initial event message from the first capability, the initial event message being received over a protocol connection;
updating the initial event message to include a correlation identifier that is associated with the protocol connection;
sending the updated initial event message through the asynchronous message bus;
receiving, through the asynchronous message bus, a response event message from the second capability; and
sending the response event message to the first capability over the protocol connection based at least in part on the response event message including the correlation identifier.

12. The computer-implemented method of claim 11, wherein the protocol connection is a hypertext transfer protocol (HTTP) connection.

13. The computer-implemented method of claim 11, wherein the initial event message is received by a server computer from a plurality of server computers, and the correlation module is further configured to map the correlation identifier to the server computer that received the initial event message.

14. The computer-implemented method of claim 13, wherein the correlation module is further configured to determine that the response event message corresponds to the computer server, and the synchronous interface is further configured to send the response event message to the first capability using the server computer.

15. The computer-implemented method of claim 11, wherein the initial event message is received in a hypertext transfer protocol (HTTP) post message.

16. The computer-implemented method of claim 15, wherein sending the response event message includes sending the response event message in a HTTP response message.

17. The computer-implemented method of claim 11, wherein sending the initial event message to the asynchronous message bus includes sending the initial event message in a hypertext transfer protocol (HTTP) request message.

18. The computer-implemented method of claim 17, wherein the HTTP request message is sent using a different protocol connection.

19. The computer-implemented method of claim 17, further comprising maintaining the protocol connection until the response event message is sent to the first capability.

20. A non-transitory computer-readable medium storing executable instructions thereon, which, when executed by a processor, cause the processor to perform operations including:
receiving an initial event message from the first capability, the initial event message being received over a protocol connection;
updating the initial event message to include a correlation identifier that is associated with the protocol connection;
sending the updated initial event message through the asynchronous message bus;
receiving, through the asynchronous message bus, a response event message from the second capability; and
sending the response event message to the first capability over the protocol connection based at least in part on the response event message including the correlation identifier.
